(19) United States
(12) Patent Application Publication
(10) Pub. No.: US 2003/0188214 A1
(43) Pub. Date: Oct. 2, 2003

(54) Method and system for efficient clock signal generation

(76) Inventors: Terry R. Altmayer, Monument, CO (US); Christopher J. Hagan, Colorado Springs, CO (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/112,787

(22) Filed: Mar. 28, 2002

(51) Int. Cl. G06F 1/04

(52) U.S. Cl. 713/500

(57) ABSTRACT

A system and method to generate at least one clock signal based on a value in a register.

The present invention relates to clock signal generation.

### DESCRIPTION OF THE RELATED ART

As the technology for manufacturing integrated circuits advances, more logic functions are included in a single integrated circuit device or a system on a chip (SoC). Modern integrated circuit (IC) devices include large numbers of gates on a single semiconductor chip, with these gates interconnected so as to perform multiple and complex functions. The fabrication of an IC incorporating such Very Large Scale Integration (VLSI) must be error free, as a manufacturing defect may prevent the IC from performing all of the functions that an IC or SoC is designed to perform. Such demands require verification of the design of the IC or SoC and also various types of electrical testing after the IC or SoC is manufactured.

However, as the complexity of the ICs and SoCs increase, so does the cost and complexity of verifying and electrically testing the individual IC or multiple ICs in a system for a SoC. Testing and manufacturing costs and design complexity increase dramatically because of the increasing number of functional pins on the integrated devices and SoC.

One way to address this problem is through design for test (DFT). DFT methods utilize various test circuits. One type of test circuit is a scan path or a scan loop in the logic circuit. A scan path or scan loop consists of a chain of synchronously clocked master/slave latches, or registers, each of which is connected to a particular node in the logic circuit. In a response to a scan clock signal, the scan latches are loaded with a serial data stream of scan vectors that set the logic circuit nodes to a predetermined state. The logic circuit then can be exercised in normal fashion, with the result of the operation stored in its respective latch. A scan out operation serially unloads the contents of the latches and the result of the test operation at the associated nodes is analyzed for improper node operation.

Automatic test pattern generation (ATPG) software generates scan vectors. As previously described, the scan path loads the scan vectors in response to a scan clock signal or clock signals. While loading the scan vector into the scan path, all the scan clock signals are simultaneously asserted. In contrast, after the scan vectors are loaded into the scan path, a single scan clock signal or subset of scan clock signals are asserted, while the remaining scan and non-scan clock signals are inactive.

Typically, a clock domain is a group of clock signals utilized for a specific purpose. For example, a clock domain may comprise a set for a functional purpose for a peripheral, such as, a memory controller. In order to generate and control the clock domains for millions of transistors on the SoC and IC for operational use and functional testing, designers struggle with the layout and control of non-scan and scan clock signals. One typical solution is balancing all the clock domains if there is interface between the clock domains or communication between the clock domains. However, a few negative consequences of this solution are increased layout complexity and an increase in silicon area because of the need for more buffers, commonly referred to as hold-fix buffers. Another typical solution is utilizing separate scan clock signals coupled to an external pin on the IC or SoC when there is communication between the clock domains. However, for a large number of internal clock domains, a negative consequence of this solution is a shortage of external pins.

### BRIEF DESCRIPTION OF THE SEVERAL VIEWS OF THE DRAWINGS

Subject matter is particularly pointed out and distinctly claimed in the concluding portion of the specification. The claimed subject matter, however, both as to organization and method of operation, together with objects, features, and advantages thereof, may best be understood by reference to the following detailed description when read with the accompanying drawings in which:

FIG. 1 illustrates a schematic diagram utilized by an embodiment.

FIG. 2 illustrates a schematic diagram utilized by an embodiment.

FIG. 3 illustrates a system utilized by an embodiment.

### DETAILED DESCRIPTION OF THE INVENTION

A method and system for efficient clock generation within an integrated device or SoC are described. In the following description, for purposes of explanation, numerous details are set forth in order to provide a thorough understanding of the present invention. However, it will be apparent to one skilled in the art that these specific details are not required in order to practice the present invention.

An area of current technological development relates to reducing test complexity and cost. As previously described, DFT methods facilitate the testing of ICs and SoCs. However, generation and control of clock domains are difficult because of the increased complexity for layout of the clock signals and utilization of an excessive amount of external pins. In contrast, a method and system that incorporates an efficient utilization of external pins to generate a plurality of clock signals based at least in part on de-multiplexing a single clock from a control word loaded from an external pin results in efficient use of external pins and reduces test costs. Thus, implementing a more efficient clock generation method and system to reduce test cost and design complexity are desirable.

In one aspect, the claimed subject matter generates a plurality of clock signals for a single clock domain in a sequential manner based at least in part on de-multiplexing a single clock from a control word loaded by an external pin. In another aspect, the claimed subject matter generates a plurality of clock signals for a plurality of clock domains in a sequential manner based at least in part on de-multiplexing a single clock from a plurality of control words loaded by an external pin. In yet another aspect, the claimed subject matter generates a plurality of clock signals for a plurality of clock domains in a substantially simultaneous manner based at least in part on a value in a register.

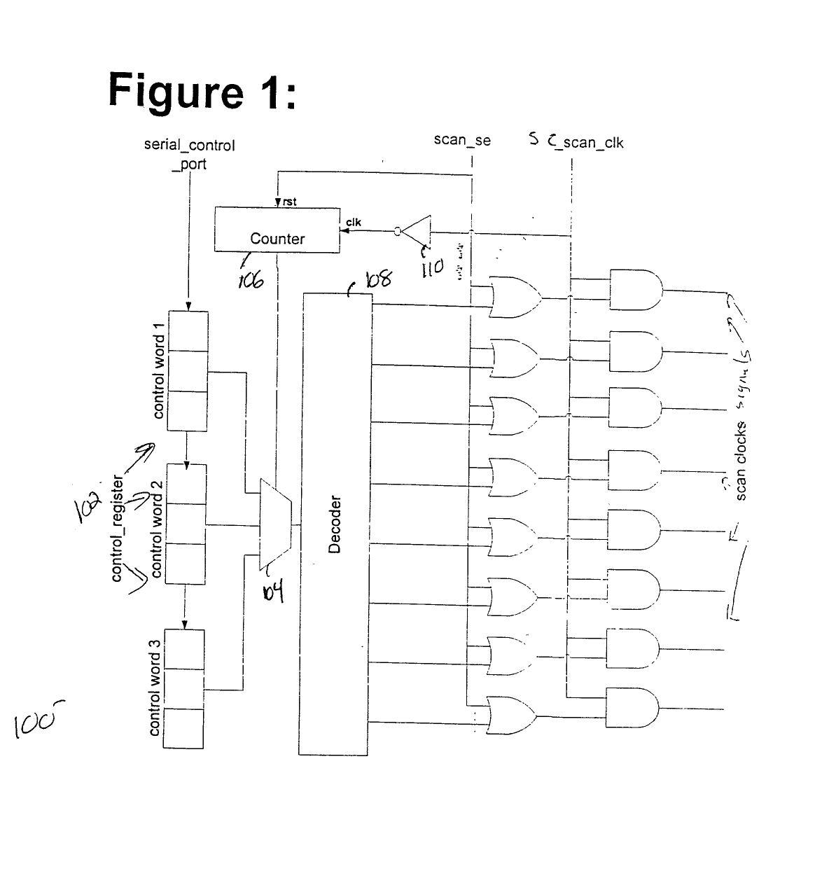

FIG. 1 illustrates a schematic diagram 100 utilized by an embodiment. The schematic diagram 100 includes, but is not limited to, a register 102, a multiplexer 104, a counter 106, a decoder 108, an inverter 110, a plurality of logic gates 112 and 114. In one embodiment, the plurality of logic gates 112 are logic OR gates and the plurality of logic gates 114 are logic AND gates. In another embodiment, either a state machine or sequencer replaces the counter.

In one embodiment, the schematic diagram 100 receives a control word from an external pin. In another embodiment, the schematic diagram 100 receives a control word from a plurality of flip-flops or latches. As previously described, ATPG vectors are utilized as scan vectors to stimulate and test the IC or SoC. ATPG vectors are applied to a device in two modes. The first mode is typically referred to as scan mode and occurs when the scan vectors are loaded by a serial shift operation. The scan mode requires a substantially simultaneous assertion of the scan clock signals. In contrast, the second mode is typically referred to as capture mode and occurs when a single clock or a group of clock signals are asserted, while the remaining clock signals are held inactive. The result of the second mode is capturing the logic values of the nodes into the scan latches to allow for analysis and test verification. However, the claimed subject matter is not limited to the two phases. For example, the two phases may be repeated. Also, more phases may be utilized to allow for resetting the device or loading one of the plurality of scan chains. In one embodiment, a scan select signal, scan_se indicates whether the IC or SoC is in scan mode or capture mode. In one embodiment, the claimed subject matter generates a plurality of scan clock signals to all of the clock domains based at least in part on a single or multiple scan clock signals for operating during scan mode.

In one embodiment, the register 102 is serially loaded from an external pin of the IC or SoC. In an alternative embodiment, the register 102 is loaded with a parallel load operation based at a plurality of external pins. In one embodiment, the register 102 contains a plurality of three bit control words that specify a clock domain. In another embodiment, schematic diagram 100 does not utilize a counter 106 and the register 102 contains a single three-bit control word. However, for both embodiments the claimed subject matter is not limited to three bit control words. For example, the control word may utilize one, two, or more than three bits to specify a clock domain. Furthermore, each control word defines a specific scan clock to be active at an output of one of the plurality of logic AND gates 114.

In the embodiment that utilizes a counter 106 and a plurality of control words, the first control word, control word 1, is selected by the multiplexer 104 based at least in part on the value of the counter 106 and is forwarded to the decoder 108. The decoder 108 generates a plurality of clock gating signals, wherein at least one of the clock gating signals is de-asserted and the remaining clock gating signals are active. In one embodiment, the plurality of clock gating signals is based on the size of the control word. For example, for a three-bit control word, the number of clock gating signals generated is eight (2 to the power of 3). The output of the decoder, the plurality of clock gating signals, is forwarded to a first input of each logic OR gate 112. In one embodiment, a scan_se signal defines whether the IC or SoC is in capture or scan mode, is coupled to a second input of each logic OR gate 112. An output of the plurality of logic OR gates 112 is applied to a first input of each logic AND gate 114. A system scan clock is applied to a second input of each logic AND gate 114.

The plurality of logic AND gates 114 generate scan clock signals for the IC or SoC. The control word 1 defined a specific scan clock to be active at the output of the plurality of logic AND gates 114. Thus, in one embodiment, one of the plurality of AND gates 114 has an output of logic 1, while the remaining AND gates 114 have an output of logic 0.

Subsequently, as the counter 106 is incremented, the previously described procedure for control word 1 is repeated for control word 2. For example, control word 2 is selected by the multiplexer 104 to be forwarded to the decoder. Eventually, one of the plurality of AND gates 114 has an output of logic 1 based on the control word and when SoC_scan_clk is active, while the remaining AND gates 114 have an output of logic 0. The procedure may be repeated for more control words and a different AND gate will have an output of logic 1 for each control word. Thus, in one embodiment, schematic 100 allows for a capture mode for different scan clock signals in a sequential manner based at least in part on the control words and the counter. However, the claimed subject matter is not limited to this embodiment of repeating the procedure for more than one control word. For example, another embodiment for schematic 100 does not utilize a counter and supports a single control word. Thus, this embodiment allows for a capture mode for one scan clock defined by a single control word.

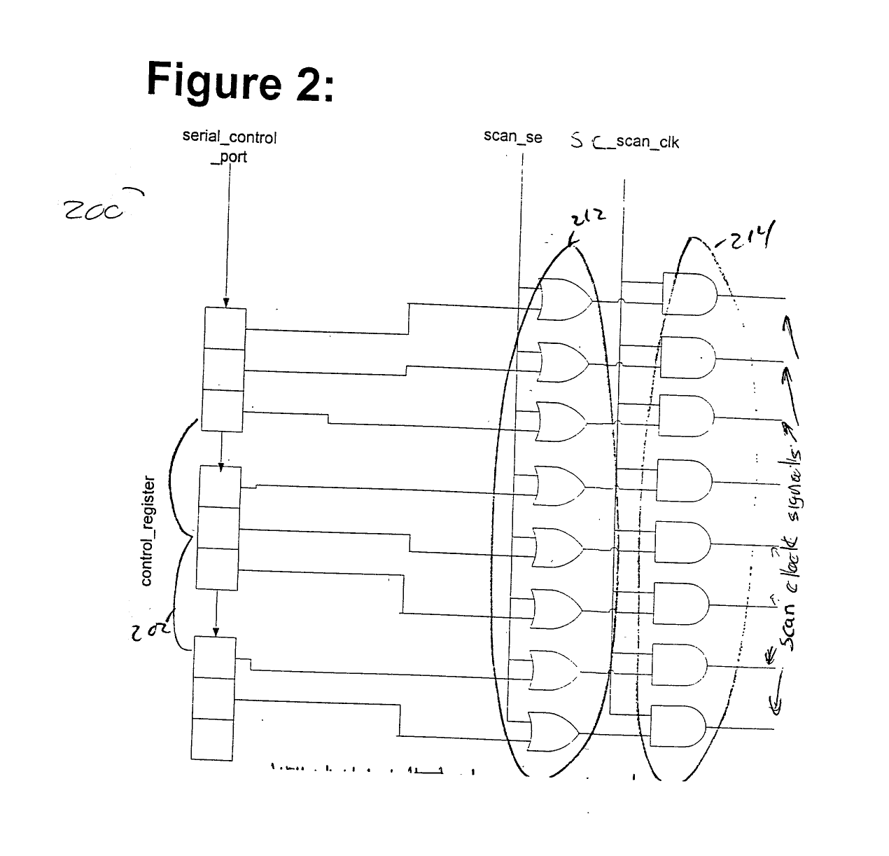

FIG. 2 illustrates a schematic diagram 200 utilized by an embodiment. The schematic diagram 200 includes, but is not limited to, a register 202, a plurality of logic gates 212 and 214. In one embodiment, the plurality of logic gates 212 are logic OR gates and the plurality of logic gates 214 are logic AND gates. The register 102 is serially loaded from an external pin of the integrated device or SoC. In one embodiment, the register 102 contains one bit fields allocated for each scan clock. Schematic 200 allows for multiple scan clock signals at an output of the plurality of AND gates 214 to be asserted simultaneously. The scan_se and system scan clock signals, SoC_scan_clk operate in the same manner as previously described in connection with FIG. 1.

The previous scan clock signal generation embodiments represent a few embodiments. In other embodiments, a four bit control word is decoded to allow for one of sixteen clock signals to be activated. In contrast, in another embodiment two four bits control words are decoded into their respective sixteen outputs which are logically ORed into one set of sixteen bit controls as input in the plurality of Logic AND and Logic OR gates, depicted in FIG. 1 and 2, to activate two scan clock signals.

In yet another embodiment, two three bits control words to define a first and second set of scan clock signals are decoded into their respective sixteen outputs. Subsequently, two scan clock signals are generated: one scan clock signal from the first set of scan signals, and another scan clock signal from the second set of scan signals. Likewise, in another embodiment, four two-bit control words to define four sets of scan clock signals are to activate four scan clock signals, one from each set. In still another embodiment, a sixteen one-bit control is to allow for independent activation of sixteen scan clock signals.

In another embodiment, a four-bit control word is to activate one of fifteen scan clock signals or no activation of a scan clock signal. As discussed in the previous embodiments, they are merely examples. For example, other embodiments may utilize different sizes for the control words

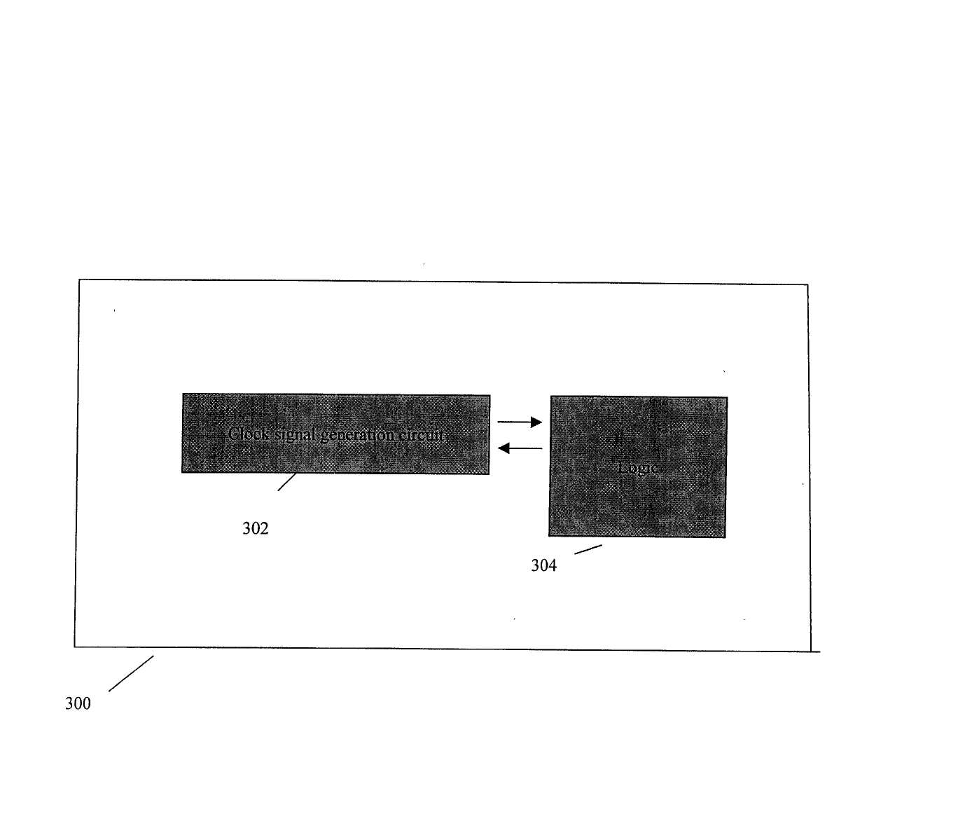

FIG. 3 illustrates a system utilized by an embodiment. The system 300 comprises a clock signal generation circuit 302 and a logic 304. The clock signal generation circuit 302 generates scan clock signals in accordance with the previously described embodiments and the scan clock signals control and enable flip flops and registers within the logic 304. In one embodiment, the system 300 is a system on a chip (SoC). In another embodiment, the system 300 is an integrated device.

While the invention has been described with reference to specific modes and embodiments, for ease of explanation and understanding, those skilled in the art will appreciate that the invention is not necessarily limited to the particular features shown herein, and that the invention may be practiced in a variety of ways that fall under the scope and spirit of this disclosure. The invention is, therefore, to be afforded the fullest allowable scope of the claims that follow.

1. A method comprising:
loading a value into a register; and
generating at least one clock signal based at least in part on the value.

2. The method of claim 1 wherein loading the value into the register comprises either shifting the value into the register via an external pin or a parallel load.

3. The method of claim 1 wherein the value is either one of a single bit or a control word.

4. The method of claim 1 wherein generating at least one clock signal is either by:
asserting a single clock signal in a sequential manner based at least in part on a the value and either a counter, state machine or sequencer; or
asserting a plurality of clock signals in a substantially simultaneous manner based at least in part on the value.

5. The method of claim 1 wherein the clock signal is a scan clock signal.

6. A method comprising:
loading a value into a register; and
generating at least one clock signal based at least in part on de-multiplexing the value.

7. The method of claim 6 wherein loading the value into the register comprises either shifting the value into the register via an external pin or a parallel load.

8. The method of claim 6 wherein the value is either one of a single bit or a control word.

9. The method of claim 6 wherein generating at least one clock signal is either by:
asserting a single clock signal in a sequential manner based at least in part on a the value and either a counter, state machine or sequencer; or
asserting a plurality of clock signals in a substantially simultaneous manner based at least in part on the value.

10. The method of claim 6 wherein the clock signal is a scan clock signal.

11. A method comprising:
loading a first value and second value into a register, wherein the first and second value to define a first set of scan clock signals and a second set of scan clock signals, respectively; and
generating at least two clock signals, one scan clock signal from each of the first and second set of scan clock signals, based at least in part on the first and second value

12. The method of claim 11 wherein loading the value into the register comprises either shifting the value into the register via an external pin or a parallel load.

13. The method of claim 11 wherein the value is either one of a single bit or a control word.

14. The method of claim 11 wherein generating at least one clock signal is either by:
asserting a single clock signal in a sequential manner based at least in part on a the value and either a counter, state machine or sequencer; or
asserting a plurality of clock signals in a substantially simultaneous manner based at least in part on the value.

15. The method of claim 11 wherein the clock signal is a scan clock signal.

16. A system comprising:
a clock signal generation circuit to store a value via at least one pin of the system to generate at least one clock signal based at least in part on the value; and
a logic, coupled to the clock signal generation circuit, to receive the clock signal(s).

17. The system of claim 16 wherein the value is a single bit or a control word.

18. The system of claim 16 wherein the clock signal generation circuit generates at least one clock signal is either one of:
a decoder, coupled to a counter, to generate the clock signal in a sequential manner, or
a plurality of combinational logic gates to generate more than one clock signal in a substantially simultaneous manner.

19. The system of claim 16 wherein the system is a system on a chip (SoC).

20. The system of claim 16 wherein the system is an integrated device.

21. The system of claim 16 wherein the clock signal is a scan clock signal.

22. A method comprising:
loading a value into a register; and
generating either at least one clock signal or no clock signal based at least in part on the value.

23. The method of claim 22 wherein loading the value into the register comprises either shifting the value into the register via an external pin or a parallel load.

24. The method of claim 22 wherein the value is either one of a single bit or a control word.

25. The method of claim 22 wherein generating at least one clock signal is either by:
asserting a single clock signal in a sequential manner based at least in part on a the value and either a counter, state machine or sequencer; or
asserting a plurality of clock signals in a substantially simultaneous manner based at least in part on the value.

26. The method of claim 22 wherein the clock signal is a scan clock signal.
